(19) United States
(12) Patent Application Publication
(10) Pub. No.: US 2017/0260778 A1
(43) Pub. Date: Sep. 14, 2017

(54) DOOR HANDLE ASSEMBLY FOR A MOTOR VEHICLE

(71) Applicant: HUF HÜLSBECK & FÜRST GMBH & CO. KG, Velbert (DE)

(72) Inventors: Martin Witte, Ahaus (DE); Andreas Beck, Bochum (DE)

(73) Assignee: Huf Huelsbeck & Fuerst GmbH & Co. KG, Velbert (DE)

(21) Appl. No.: 15/509,383

(22) PCT Filed: Aug. 10, 2015
(86) PCT No.: PCT/EP2015/068385

§ 371 Date: Mar. 7, 2017

(30) Foreign Application Priority Data
Sep. 8, 2014 (DE) 10 2014 112 884.2
Jan. 7, 2015 (DE) 10 2015 100 074.1

(51) Int. Cl. B60R 16/023; E05B 85/10

(52) U.S. Cl. CPC E05B 81/77; E05B 85/10

(57) ABSTRACT

A vehicle door handle includes a sensor assembly for detecting an operation request. The door handle is fixed and actuates an electric lock. The sensor assembly includes a first capacitive sensor arranged in the door handle and oriented towards an inner side of the handle. It monitors a first handle section gripped when actuating the handle. Second and third sensors are arranged along an axial extension of the handle. The second sensor is oriented towards an outer side of the handle and monitors a touching from the outer side in a second handle section. The third sensor is oriented towards the inner side of the handle and monitors a touching from the inner side. The electronic control and evaluation device generates an opening signal when both the capacitive sensor detects a gripping of the door handle and the second sensor and the third sensor simultaneously each detect a touching.

The invention relates to a door handle assembly for a motor vehicle. The invention particularly relates to an outer door handle assembly for actuating an electric door lock.

Electrically-controlled door locks are known from the prior art. These are frequently listed under the general term “e-latch”. Such a door lock is disclosed in the EP 0 584 499 A1. In such door handles, there is no arrangement for a continuous mechanical functional chain from the door handle to a corresponding door lock. The door lock is rather controlled electrically, so that mechanical hardware can be reduced, which saves cost and weight.

An electrically controlled lock has to be differentiated from the well-known concepts of a remote controlled door unlocking. It might still be possible to mechanically open an unlocked door by actuating the door handle, in order to lift the lock release of the mechanical components of the door lock (in particular rotary latch and pawl). In an electric door lock, this releasing of the lock is carried out after an electrical actuation, the rotary latch of a door lock is thus operated via an electrical activation and by means of a corresponding servo unit or motor unit without the need to exert any force on the door handle.

In such electric door locks, the mechanical deflection or adjustment of the door handles is no longer necessary, they can therefore be mounted to the motor vehicle with no or only a minimal range of motion (e.g. to activate a microswitch).

This application relates to a door handle that is fixed on the vehicle, referred to as fixed door handle in the following. This should convey the meaning that the door handle with its handle that can be operated by the user cannot be deflected or pivoted in relation to the corresponding door, but that it merely serves as a handle to move the door which was electrically opened.

It has to be ensured at all times that the production and maintenance of these door handles will require as little effort as possible on the one hand, and that the security of such a door handle system is guaranteed at all times. In particular, if the opening of the door is carried out via an electric door lock after an actuation, it has to be ensured that the opening request of a user is indeed determined without any uncertainty. Any pressure onto the door handle, e.g. in a car wash, when polishing the motor vehicle, by means of the airstream or when someone is leaning against it, should never cause an undesired opening of the door.

It is the objective of the invention to produce a fixed door handle with a reliable function detection and increased security.

This objective is achieved according to the invention by means of a door handle device with the characteristics of claim 1. The objective is furthermore realized by means of a method with the characteristics of claim 8.

The door handle device according to the invention is designed with a mechanically stable handle/grip portion which can be mounted to the motor vehicle with at least one attachment section. The attaching of a handle that is facing towards the outside onto the motor vehicle can be achieved, for example, by attaching at the door panel itself, or by reaching through the door panel and mounting attachment sections to a carrier that is located on the inside of the door panel. The term mechanically stable conveys the meaning that the handle is not designed for a movement or displacement by means of joints, bearings, guides, elastic agents or the like. However, a deforming within the elasticity range of the handle material, while operating the handle, is provided.

The door handle according to the invention comprises a plurality of sensors, wherein at least one of these sensors is a capacitive proximity sensor.

The capacitive proximity sensor is arranged within the handle in such a way that a reaching behind and grasping of the handle is detected by the capacitive proximity sensor. The arrangement of such capacitive sensors in door handles is known, it is used in particular in so-called “keyless entry systems”. As an example, it is hereby referred to the application DE 10 2005 055 515 A1.

Capacitive sensors are capable of detecting the approach of a body part of the user, in particular the placing or approaching of a hand on the door handle. In accordance with the invention, the capacitive sensor is aligned towards the inside of the door handle, so that a reaching behind and grasping of the door handle is monitored. The capacitive sensor is therefore used in the door handle according to the invention, in order to detect the presence of the operator's hand behind the handle and thus to detect a reaching behind and grasping.

At least two more sensors are furthermore provided. These sensors are arranged in the handle in such a way, that they are placed along the perimeter of the handle at different angular positions, especially in positions on the handle that are facing away from each other. The arrangement of these two sensors is therefore made in such a way, that in one section of the handle, for example, one of the sensors is facing towards the outside, while the other sensor is facing towards the inside within the same section of the handle. Within the same section of the handle means that the detecting ranges of the second and the third sensor in axial direction of the handle are arranged in the same direction with an offset in relation to the direction of the capacitive sensor in the door handle.

It is essential that the capacitive sensor in the door handle arrangement according to the invention can detect a reaching behind and grasping of the handle and the two other sensors detect a reaching around or a clasping in one section of the handle. It is for example possible that the two further sensors are arranged in the particular area in which the index finger and thumb of an operator normally come to rest during a usual operation of the door handle. While the first sensor is designed as a capacitive sensor for the monitoring of a reaching behind and grasping of the handle, the further sensors can be capacitive sensors as well as sensors of other kinds, e.g. inductance to digital converters (LDCs). The manner of detecting is initially not essential for the invention. For example, the sensors that are arranged facing away from each other can both function as capacitive sensors, so that a reaching behind and grasping can be detected in this section. If the door handle is thus reached behind and also grasped in the correspondingly monitored section, an operating request is assumed and the electronic door lock is actuated. However, in a further development of the invention it is provided, that one of the further sensors is designed as a force-sensitive sensor. Although the door handle is designed as a fixed door handle, it is generally possible that it can be designed to be mechanically deformable in sections or to have deformable covers. For this purpose, it is possible to design elastically deformable cover parts or sections; however the material of the handle body itself can allow slight elastic deformation.

Such a force-sensitive sensor can be realized e.g. by means of a piezo, whose piezo voltage is monitored.

The arrangement according to the invention of multiple sensors in the door handle, which monitor a reaching behind as well as at least a partial grasping of the door handle, significantly increases the security of the door handle. When using fixed door handles, which monitor e.g. a deformation of the handle, there is a danger that deformations, for example, when the car is driving or while cleaning the vehicle or also torsional deformations when the vehicle is parked on uneven surfaces (parking with two wheels on an elevated walkway), are recognized as an actuation of the handle.

Naturally, the detection of a deformation of a fixed door handle must also be very sensitive, because otherwise excessive forces would be required when the user operates the door. This however causes such systems that are in accordance with the prior art to be very sensitive with regard to false detections of actuations. The arrangement of a capacitive monitoring of a reaching behind and the additional monitoring of a grasping in accordance with the invention protects against such false detected actuations.

The electrical opening is only carried out if the sensor signals indicate that there is a clear operation request.

The sensors installed in the handle can be monitored for further operating tasks. It is e.g. possible that a locking of the lock is carried out after the door is closed, when the user places his hand on the outside of the door handle within the monitored area and rests it there for a pre-defined period of time.

In a preferred embodiment of the invention, the door handle arrangement is connected in such a way, that the sensors for the monitoring of a grasping of a section of the handle are initially disabled, while the capacitive sensor for the monitoring of a reaching behind and grasping is active. As soon as a reaching behind and grasping is detected, the other sensors are activated and monitored. In this configuration, the energy consumption of the door handle is optimized while the safety and comfort are fully maintained.

In a particularly preferred embodiment, the one sensor from the further sensors that is facing towards the inside of the handle is designed as a force sensor, while the sensor that is aligned towards the outside is designed as a capacitive sensor. As already described above, a force-sensitive sensor can e.g. be equipped with a piezo sensor or with a LDC sensor or also with a Hall sensor, wherein these sensors are thereby arranged in the inside of the handle in such a way, that pressure which is exerted onto the corresponding door handle area when grasping the same causes a deformation of the housing in this section, which triggers a sensor signal.

Designing a sensor that is directed towards the inside as a pressure sensor or force sensor further reduced incorrect actuations. When driving through a car wash, there are situations for example, in which parts of the washing brushes surround the door handle from both sides, which could be erroneously detected as a grasping. However, if a pressure is built up on the inside of the door handle, e.g. by a pulling on the door handle, then such a pressure force is usually not built up during such washing procedures and incorrect actuations are thus avoided.

Furthermore, such a design has the significant advantage that a required tight grasping of the door handle prevents an awkward touch or even injury on the back of the hand when the door pops open. It has to be kept in mind that in an electrically operated door lock, the door opening is activated and carried out electrically, and the door is accordingly actively accelerated at least a few centimeters from its closed position towards the open position by an electric drive. A user who reaches with his hand into this area, in order to initiate the opening could be surprised by this active acceleration of the door with his hand on the door handle, and possibly receive a hit on the inserted hand. If however a firm grasp and a tight pressing on the inside of the door handle is required to initiate an opening of the door, it can be ensured that the user is protected against such a hit, since the exerted force of the user is in the same direction as the opening.

In a further development of the invention it is provided, that further sensors are designed along the handle. These sensors monitor an exerting of force in further areas along the handle. Several LDC sensors are for example distributed along the inside of the handle for this purpose and detect a deforming of the housing of the door handle. It is not complicated to design such LDC sensors on a control electronics on the inside of the handle, in that a coil is designed on a circuit board and a metallic element is placed on the opposite side of the handle, e.g. adjacent on the inner side of the handle housing. If the housing is deformed, the adjacent metal piece opposite the coil arrangement moves and the sensors are activated. To accomplish this, it can also be provided that the mechanical deformability in this area is specifically influenced, e.g. by means of designing the inside of the fixed door handle with an elastic material.

Preferably, all sensor components and the associated circuit in the inner part of the handle are furthermore sealed with an elastic sealing compound, so that they are protected against environmental influences and at the same time the elastic sealing compound provides a certain resilience, e.g. for the distance of the metallic elements to the coils of the LDC sensors.

These other sensors on the inner side of the door handle that are sensitive to a deforming or to force can be arranged in addition to the sensors that monitor the reaching behind and grasping of the handle in a pre-defined section of the handle. In addition to a capacitive monitoring of a reaching behind and grasping, it is possible to monitor whether a pulling force can be detected within a larger section of the handle during an operation request. It is also possible to assign the operation of different portions of the handle to different patterns of actuation.

The method in accordance with the invention uses the arrangement of the various sensors in the door handle, in order to determine a clear operation request. For this it comprises the steps:

Detecting of a reaching behind and grasping of the door handle within a first section by means of a monitoring of the signals of a first capacitive sensor of the sensor assembly,

detecting of a touching of the door handle from the outside within a second section by means of a monitoring of the signals of a second sensor of the sensor assembly,

detecting of a touching of the door handle from the inner side within the second section by means of a monitoring of the signals of a third sensor of the sensor assembly,

generating control signals with the electronic control and evaluation device, wherein an opening signal is generated when at the same time a reaching behind and grasping of the door handle is detected and the second and third sensors each detect a respective touching.

In accordance with this method, it is essential that the sensor signals are evaluated in combination knowing the arrangement of the sensors in the handle. It is mandatory that the sensor signals must occur at the same time, accordingly the sensors must simultaneously detect an operation. The signals are thus linked by an AND-condition, so that only those cases are identified as an operation that reflect an operating pattern that can be linked to a human hand and operating practice.

The invention will now be explained in more detail by means of the attached exemplary figures.

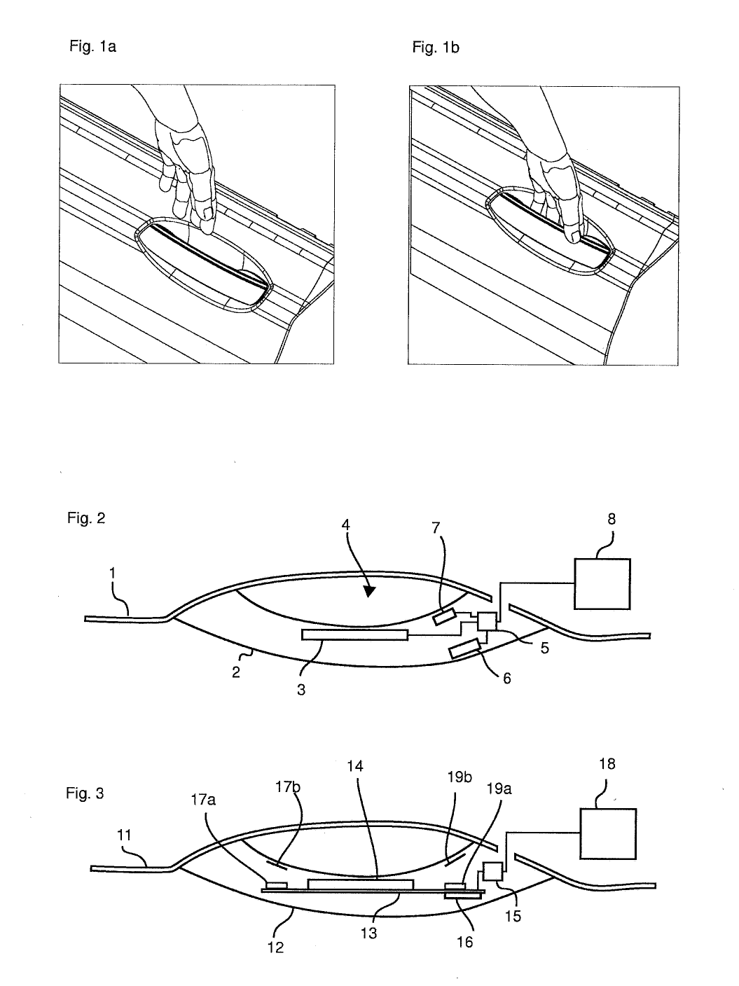

FIG. 1a depicts the approaching of a hand to a fixed door handle;

FIG. 1b depicts a reaching behind and grasping of the fixed door handle;

FIG. 2 depicts a schematic representation of the arrangement of components within the fixed door handle according to a first embodiment;

FIG. 3 depicts a schematic representation of the arrangement of components within the fixed door handle according to a second embodiment.

FIGS. 1a and 1b clarify what is to be understood in the context of this description by a reaching behind and grasping of a fixed door handle. In FIG. 1a, a user approaches a fixed door handle of a vehicle door. As it is described further in the following, the fixed door handle is immovably attached to the vehicle door. According to the invention, sensor components in the fixed door handle, in particular a capacitive proximity sensor, monitor if the hand of the user is actually located behind the door handle. As exemplified in FIG. 1b, the associated capacitive sensor only produces a corresponding signal if the hand has reached behind the door handle. To date, appropriate approximations of a hand behind the door handle are used for example in capacitive sensors in keyless entry systems.

If the user moves his hand into the position of FIG. 1b, the triggering of the capacitive sensor activates a number of other sensors in the door handle, as shown below.

FIG. 2 depicts a first embodiment of a door handle according to the invention in a schematic representation. A schematic section through the door handle is shown, as it is depicted in the FIGS. 1a and 1b in a three-dimensional representation. The door handle is firmly arranged on a door panel 1, wherein a handle 2 is intended to be e.g. in the end sections on that door panel. It is possible to provide mounting elements on one side of the handle, which can also reach through the door panel 1, but details are not depicted in this case as they are not relevant for the invention. A capacitive sensor 3 is arranged on the inside of handle 2. This sensor is directed towards the inside of the handle, thus towards the side of the door and monitors the reaching behind and grasping of a hand into the open space 4 behind the handle. The capacitive handle can e.g. be designed in a shielded manner towards the outside, in order to be insensitive with regards to any approaching from the outer side. It is for example possible to equip the capacitive sensor system 3 with a sensor electrode and an active shield, as it is known from the prior art in so-called active-shield sensors.

The capacitive sensor 3 is connected to a control unit 5. According to this embodiment, the capacitive sensor 3 is held active all the time, so that a reaching behind and grasping of the door handle can be detected. If such a reaching behind and grasping occurs, the control unit 5 activates the sensors 6 and 7. Sensor 6 is another capacitive sensor that uses its field of detection to monitor a short area on the side of the door that is facing towards the outside. On the side of the handle that is facing away from the area that is monitored by sensor 6, a force-sensitive sensor 7 is arranged. This sensor is designed as a piezo sensor in this embodiment, and it is connected to the handle surface on the inside. Sensor 6 monitors an approaching of the thumb of a hand of the user, while sensor 7 monitors the exertion of pressure on the inside of the handle. For this purpose, the immediate area in front of sensor 7 can be made from a deformable material, e.g. from an elastomer, if the handle material as such only allows for extremely limited deformations.

Control unit 5 is coupled with the electronic lock 8, which can be caused to open the door when it is activated. Lock 8 is depicted symbolically here, it may particularly comprise an electrically actuated rotary latch which can securely hold or open the door in cooperation with a locking pin.

The control unit 5 monitors the signals from the capacitive sensor 3 as well as the capacitive sensor 6 and the piezo sensor 7. Only when all three sensors indicate that the user's hand has reached behind the door handle and a thumb portion is positioned in front of sensor 6, as well as pressure is applied onto sensor 7, a deliberate operation of the door is detected, and lock 8 is unlocked. This coupling of the sensors leads to a particularly reliable detection of a conscious and deliberate actuation. Force sensor 7 also ensures that the door handle is firmly grasped and a force is exerted in the opening direction. Thus, the electric door opening cannot unpleasantly surprise the user, since his applying of force is already exerted in the opening direction and correspondingly, the door cannot hit against his hand, in particular, against the back of his hand.

By means of this schematic diagram it is clear, that random environmental influences can hardly cause an activation. Only if an object reaches behind the door handle and from there exerts pressure onto the inner sensor 7 and there is an approaching from the outside at the same time, an opening request would be detected.

Generally, it is also possible to design sensor 6 as a pressure sensor, so that it is necessary to apply a squeezing force on sections of the door handle that are facing away from each other in the region of the sensors 6 and 7, in order to achieve a door opening.

In that case, sensor 6 may also be formed as a piezo sensor or as another force sensor.

FIG. 3 depicts another embodiment with a grip handle 12, which is fixed to a door panel 11. In this embodiment, all sensor components are arranged on one circuit board 13. The capacitive sensor 14 is arranged in the center region of circuit board 13, to the left of the capacitive sensor 14, an inductive sensor 17a, 17b is arranged. A coil assembly 17a is mounted on circuit board 13 and a metallic sensor part 17b is positioned with some distance to the coil assembly 17a on the inner side of the handle. A corresponding sensor design is also arranged on the right side of the capacitive sensor 14 in form of the sensor 19a, 19b. A metallic part 19b is attached on the inner side of the handle, while a coil assembly 19a is arranged on circuit board 13. A further capacitive sensor 16 in turn monitors the portion which faces away from the vehicle in this section.

The circuit board is connected to a control unit 15, whereby this control unit 15 may generally also be arranged on the circuit board itself. A door lock 18 can be controlled by control unit 15 and can be caused to open. Sensors with inductive coupling are known from the prior art, in particular as so-called LDC sensors. This embodiment comprises a total of four sensors for the monitoring of an actuation. The sensors 17a and 19a detect a change in the distance or change in position of the metallic parts 17b, 19b with regard to the respective sensor 17a or 19a. However, these sensors generally react to changes in position, so that, for example, a twist of the door handle or a deformation could already be detected as an actuation. It is not possible to determine with these sensors whether the coils come closer to their respective counterparts, or if the handle is deformed or engaged from its inner side. This is where the capacitive proximity sensor 14 comes into play, which carries out the monitoring of a reaching behind and grasping according to the before-mentioned explanation. Only when a reaching behind and grasping of the handle is detected as well as an actuation by a deformating of the door handle, and furthermore a touch has occurred in the region of sensor 16 on the outside, control circuit 15 will detect an actuation of the door handle and open the door lock.

The depicted embodiments significantly increase the security in the detection of a clear operation request. The safety of the controlling of electric door locks by means of fixed door handles is thereby increased.

1. Vehicle door handle including a sensor assembly for detecting an operation request, wherein the vehicle door handle is formed as a fixed door handle for actuating an electric lock (e-latch),
wherein the door handle is shaped in such a manner that a user in order to actuate it reaches behind the door handle into an open space between the door handle and the vehicle door, wherein a side of the door handle that is directed towards the vehicle is referred to as the inner side of the door handle and a side of the door handle that is facing away from the vehicle is referred to as the outer side, wherein the door handle comprises an eletronic control and evaluation device, which generates control signals for the electric door lock in dependence on signals from the sensor assembly,
wherein
the sensor assembly has at least one first capacitive sensor that is arranged in the door handle, whereby the at least one capacitive sensor is oriented towards the inner side of the door handle, and monitors a first handle section which is to be reached behind and grasped when actuating the handle, wherein the sensor assembly comprises at least a second and a third sensor which are arranged along the axial extension of the handle in an offset manner in relation to the capacitive sensor in the door handle,
wherein the at least one second sensor is oriented towards the outer side of the door handle, and monitors a touching of the door handle from the outer side in a second handle section, and
wherein the at least one third sensor is oriented towards the inner side of the door handle, and monitors a touching from the inner side in the second handle section,
wherein the sensor assembly is connected to the electronic control and evaluation device and wherein the electronic control and evaluation device generates an opening signal, when the capacitive sensor detects a reaching behind and grasping of the door handle, and at the same time the at least one second sensor and the at least one third sensor simultaneously each detect a touching.

2. Vehicle door handle according to claim 1, wherein the electronic control and evaluation device is designed for the activation and deactivation of the at least one second and third sensors, whereby the electronic control and evaluation device monitors the at least one first capacitive sensor and activates the at least one second and third sensors in dependence on the signals from the at least one first capacitive sensor.

3. Vehicle door handle according to claim 1, wherein the at least one third sensor is designed as a force sensor, in particular as a piezo sensor or as a LDC-sensor.

4. Vehicle door handle according to claim 3, wherein the door handle is designed in a mechanically deformable manner, at least in sections, within the area of the at least one third sensor, so that a force transmission towards the sensor that is arranged within the door handle is improved, whereby the handle is arranged at least partially with a cover made from an elastomer in the section that is covering the at least one third sensor.

5. Vehicle door handle according to claim 1, wherein the at least one second sensor is a capacitive sensor.

6. Vehicle door handle according to claim 1, wherein the at least one second sensor is a force sensor.

7. Vehicle door handle according to claim 1, wherein additional force sensors are arranged along the handle extension, which detect the exerting of force from the inner side of the handle.

8. Method for detecting an operation request on a vehicle door handle, wherein the vehicle door handle is designed as a fixed door handle for actuating an electric lock (e-latch),
whereby the door handle is shaped in such a manner that a user in order to actuate it reaches behind the door handle into an open space between the door handle and the vehicle door, wherein the side of the door handle that is directed towards the vehicle is referred to as the inner side of the door handle and the side of the door handle that is facing away from the vehicle is referred to as the outer side,
wherein the door handle comprises an electronic control and evaluation device, which generates control signals for the electric door lock in dependence of on signals from the sensor assembly,
wherein a sensor assembly is designed for the detecting of an operation request,
comprising the steps of
detecting of a reaching behind and grasping of the door handle within a first section by means of a monitoring of the signals of a first capacitive sensor of the sensor assembly,
detecting of a touching of the door handle from the outside within a second section by means of a monitoring of the signals of a second sensor of the sensor assembly,
detecting of a touching of the door handle from the inner side within the second section by means of a monitoring of the signals of a third sensor of the sensor assembly,
generating control signals with the electronic control and evaluation device, wherein an opening signal is generated when a reaching behind and grasping of the door handle is detected and at the same time the second and the third sensor each detect a respective touching.

9. Method according to claim 8, wherein an activation and monitoring of the second sensor and of the third sensor is only carried out when a reaching behind and grasping of the door handle is detected.

10. Method according to claim 8, wherein a force exertion on the inner side of the door handle is detected by means of the third sensor.
